(19) United States
(12) Patent Application Publication
(10) Pub. No.: US 2025/0207374 A1
(43) Pub. Date: Jun. 26, 2025

(54) BACK FLOW PREVENTER

(71) Applicant: Robo-Fit,LLC, Twinsburg, OH (US)

(72) Inventor: William Andrew Pretorius, Chagrin Falls, OH (US)

(21) Appl. No.: 18/391,603

(22) Filed: Dec. 20, 2023

(51) Int. Cl. E03B 7/07; F16K 11/10

(52) U.S. Cl. CPC E03B 7/077; F16K 11/105

(57) ABSTRACT

A back flow preventer includes a housing having an inlet section defining an inlet, a central section, and an outlet section defining an outlet, an internal passageway, a primary check valve, a secondary check valve, and a vent assembly. The inlet section, central section and outlet section are coupled together and axially aligned with one another. The internal passageway is defined through the housing between the inlet and the outlet. The primary check valve is coupled between the central section and the outlet section in the internal passageway. The secondary check valve is coupled between the central section and the inlet section in the internal passageway. The vent assembly is positioned in the central section and coupled to a vent opening. The primary check valve is retained in the housing independently from the secondary check valve.

### FIELD

The present invention concerns a back flow preventer for use in preventing back flow into the water supply and other systems.

### BACKGROUND

Carbonated beverage dispensers employ a carbonator tank in which water is mixed with carbon dioxide to form carbonated water. The carbonated water is subsequently mixed with a formula to form a carbonated beverage. In such a system, it is undesirable for backflow to occur. Backflow is the reversal of the flow of water or mixtures of water and other substances back into the potable water supply serving the beverage dispenser. Backflow can result in corrosion, caused when carbonic acid is exposed to copper plumbing.

The compounds formed in the reactions between carbonic acid and copper, such as copper carbonate (CuCO3), copper hydroxide (Cu(OH)2Cu(OH)2), and copper oxide (CuO), are generally not highly toxic. However, excessive exposure to copper or its compounds can lead to health concerns. Ingesting or inhaling large amounts of copper can cause symptoms such as nausea, vomiting, diarrhea, and stomach cramps. Prolonged exposure to high levels of copper may lead to more severe health issues, including liver and kidney damage.

Backflow can occur when pressure in the carbonator tank is greater than the supply pressure of the water. In this case, the mixed fluid can flow backwards and contaminate the water supply.

A vented dual check back flow preventer may be used in such systems to isolate the carbonator tank from the drinking water supply. This type of back flow preventer employs a vent between a pair of check valves that only allow fluid to travel in one direction, which prevents carbonated water from contacting copper plumbing used with the drinking water supply. In the event a check valve fails, the carbonated water in the back flow preventer will be channeled out of the vent between the check valves and will not enter the drinking water supply.

ASSE International provides product performance standards, developed through industry consensus, that detail how a product is intended to function under normal operating conditions and includes testing procedures and requirements for performance, health and safety. ASSE 1022 covers a backflow prevention device designed to protect the potable water supply serving beverage dispensing equipment. These devices are intended for use under continuous or intermittent pressure conditions.

ASSE 1022-2021 covers a standard backflow preventer for beverage dispensing equipment that includes two check valves and an atmospheric vent. This vent, or atmospheric port, is located between two independently acting check valves biased to a normally closed position. The vent opening leaks water when the downstream check valve of the device fails. In this manner, a user can determine when part of the valve fails so that it can be replaced instead of allowing backflow into the water supply.

With these three key components, the device is engineered for installation in carbonated post-mix dispensing systems. ASSE 1022-2021 details an array of performance tests, including those for hydrostatic pressure, atmospheric port leakage, water flow, temperature extremes, check valve sealing pressure, endurance, atmospheric port-opening pressure, and check valve leakage. The standard also covers requirements for materials and toxicity, design and construction, markings, and installation instructions.

### SUMMARY

The present invention concerns a back flow preventer for use in preventing back flow contamination into the water supply. The back flow preventer includes two independently retained check valves, positioned inside a housing. The check valves are independently retained in the housing and do not include a single retainer, where the single retainer holds both check valves in position. As such, the check valves are not physically linked to one another in the housing. Because the check valves are independently retained in the housing, the design is simplified. The present invention also utilizes push-to-connect connections, a feature not currently offered in the present market.

### BRIEF DESCRIPTION OF THE DRAWINGS

FIG. 1 depicts a perspective exterior view of a back flow preventer valve according to the invention;

FIG. 2 depicts a cross-sectional view of the back flow preventer valve of FIG. 1;

FIG. 3 depicts a cross-sectional view of a flow pattern of the back flow preventer of FIG. 1 during normal operation; and

FIG. 4 depicts a cross-sectional view of a flow pattern of the back flow preventer of FIG. 1 during a primary check valve failure.

### DETAILED DESCRIPTION:

The present invention concerns an improved back flow preventing device 10 in the form of a multi-part housing and a pair of check valves 24, 26 that are not mechanically linked. The multi-part housing includes a central section 14, an inlet section 16, and an outlet section 18. An inlet 12 is positioned at the free end of the inlet section 16 and an outlet 17 is positioned at the free end of the outlet section 18. The inlet section 16 and outlet section 18 include a recess formed in each end of the device 10 that each define cavities. In the example shown in the figures, the inlet and outlet sections 16, 18 include cavities for inserting cartridges having push-to-connect ends 34, 36. The inlet 12 and outlet 17 are associated with the push-to-connect ends 34, 36. The push-to-connect ends 34, 36 are serviceable by replacing the inserted cartridge itself instead of replacing the entire device 10. The push-to-connect ends 34, 36 are compatible with NSF 61 tubing, which is a feature not presently found in the market.

The back flow preventer 10 of the present invention utilizes a cylindrical needle check valve 24 paired with a diaphragm check valve 26. These types of check valves are known in the art. The cylindrical needle check valve serves as the primary check valve 24 and the diaphragm check valve serves as the secondary check valve 26. The primary check valve 24 is positioned downstream of the secondary check valve 26 in the housing of the device 10. The primary and secondary check valves 24, 26 are axially aligned.

The back flow preventer 10 is designed primarily for use in carbonation systems to prevent back flow into the water supply. Back flow can potentially cause damage to water lines. While the herein described back flow preventer 10 is primarily designed for use in carbonation systems, it could alternatively be used for other systems that require back flow prevention.

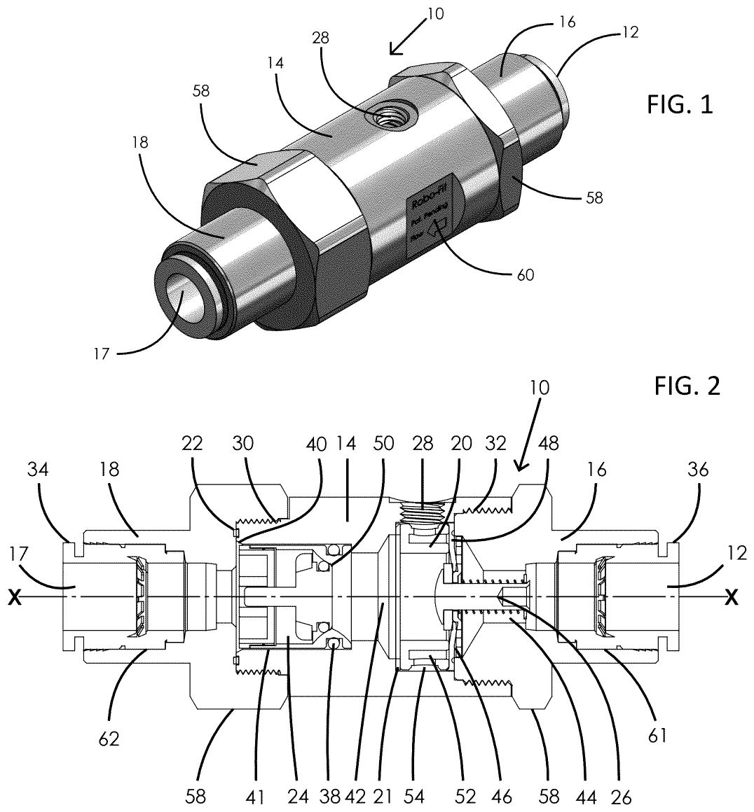

Referring to the figures, FIG. 1 depicts an isometric view of an example back flow preventer 10 according to the invention. FIG. 2 depicts a cross-sectional view of FIG. 1 taken along a centrally disposed longitudinal axis X-X. The housing of the back flow preventer 10 is formed from multiple parts 14, 16, 18 that together form a longitudinally extending internal passageway 44 formed along the length of the housing. The internal passageway 44 extends through the inlet section 16, the secondary check valve 26, the central section 14, the primary check valve 24, and the outlet section 18, as shown in the figures. The back flow preventer 10 also has an external surface that includes an inlet section 14 bounded by a bolt hex head shaped member 58, a central section 10 including a wrench pad 60, and an outlet section 12 bounded by a bolt hex head shaped member 58. A push-to-connect fitting 34, 36 is positioned inside cavities 61, 62 formed on the ends of the inlet and outlet sections 16, 18 at both ends of the housing. The internal passageway 44 is axially aligned along the length of the body.

The central section 14 includes outwardly facing screw threads 30 on the outlet section 16 that couple with inwardly facing screw threads 32 on the inlet section 14. The thread diameter of the inlet section 14 is larger than that of the outlet section 16. This is due to the constraints of the engineered cavities on either section.

The central section 14 is joined with the outlet section 18 by screwing the two parts together. The central section 14 is joined with the inlet section 16 by screwing the two parts together. In particular, a collet can be utilized to hold the respective ends 16, 18 in a fixed position while a torque wrench is used to tighten the central section 14 on the wrench pad 60 to 25 ft-lbs.

The internal passageway 44 narrows between the inlet end 12 of the push-to-connect fitting 36 where it meets a check valve 26. One type of check valve utilized at the inlet end 12 is a diaphragm check valve. The diaphragm check valve serves as the secondary check valve 26 is positioned first within the flow path of the back flow preventer.

The primary check valve 24 is positioned downstream from the secondary check valve 26 so that if the primary check valve 24 fails during a back flow event, the secondary check valve 26 can block the flow of fluid from the outlet 17 to the inlet 12. One type of primary check valve 24 utilized at an outlet end 40 of the central section 14 is a Neoperl valve 24, which is a self-contained check valve. The Neoperl check valve 24 utilized has a low cracking pressure and low head loss that fits into the cavity on the outlet end 40 of the central section 14. The Neoperl check valve 24 faces the outlet section 18 of the backflow preventor 10. The Neoperl check valve 24 can be swapped out for a different design as long as the cavity dimensions are the same and the operational features are similar.

The Neoperl check valve 24 is inserted into an interior cavity 41 of the internal passageway 42 of the central section 14 at the outlet end 40 of the central section 14 thereof. The Neoperl valve 24 may be press-fitted with silicone grease into the opening in the outlet end 40 and is axially aligned with the longitudinal axis X-X of the internal passageway 44. The Neoperl valve 24 is independently retained in the internal passageway of the central section 14. An O-ring seal 38 is positioned at the forward end of the Neoperl check valve 24 and assists in deterring or preventing fluid from bypassing the valve 24 during normal operation.

The internal passageway 42 of the central section transitions from wider to narrower at the front end of the Neoperl check valve 24. A vent opening 28 is provided adjacent the inlet end 46 of the central section 14. The vent opening 28 is utilized to vent fluid from the backflow preventer 10 in the event of failure of the primary check valve 24. The vent 28 is normally closed off during normal operation because the diaphragm check valve 26 is deflated. The vent 28 is positioned at the widest diameter of the internal passageway 42 of the central section 14. The vent 28 is coupled to a vent assembly that includes a cylindrical retainer 20, a gasket 21, and the diaphragm check gasket 48 that pair together. The vent assembly includes a first passageway 52 which is a cylindrical recess defined on an outer surface of the retainer 20. The first passageway 52 transfers fluid to a second passageway 54 and out the vent hole 28 during backflow conditions.

The cylindrical retainer 20 is positioned in the central section 14 and couples with the secondary check valve 26. When a diaphragm check valve is used as the secondary check valve 26, the diaphragm check valve inflates or expands against backflow pressure when the primary check valve 24 fails. In that case, as shown in FIG. 4, fluid is released through the channels 52, 54 located in the vent assembly and out of the device 10 through the vent hole 28. When fluid flows through the vent opening 28, this is the indicator utilized in an ASSE 1022 Backflow Preventer to signal to the user that a check valve has failed. FIG. 4 illustrates the flow pattern of the venting feature during a backflow condition where the primary check valve 24 has failed.

The secondary check valve 26 is positioned adjacent the cylindrical retainer, with the diaphragm gasket 48 positioned between the inlet section 16 and the retainer 20. The diaphragm gasket 48 is positioned within the diaphragm check valve 26 and serves as the face seal on the inlet end 46 of the central section 14.

The retainer 20 and gasket 48 together hold the secondary check valve 26 in position. The gasket 48 normally blocks the flow of fluid through the vent opening 28 during normal operation, where flow moves from the inlet 12 to the outlet 17. If the primary check valve 24 fails and backflow occurs, the flow of fluid moves forward from the outlet 17 toward the inlet 12. The force of the flow of fluid forces the secondary check valve 26 to move towards the inlet 12. This in turn pushes the gasket 48 toward the inlet 12 and the secondary check valve 26, opening a flow path 52, 54 between the gasket 48 and the vent opening 28, permitting fluid to escape from the vent opening 28.

The outlet end 40 of the central section 14 includes a male thread 30 that seals on a face-seal gasket 22. This mates against a bored-out wall located on the outlet section 18.

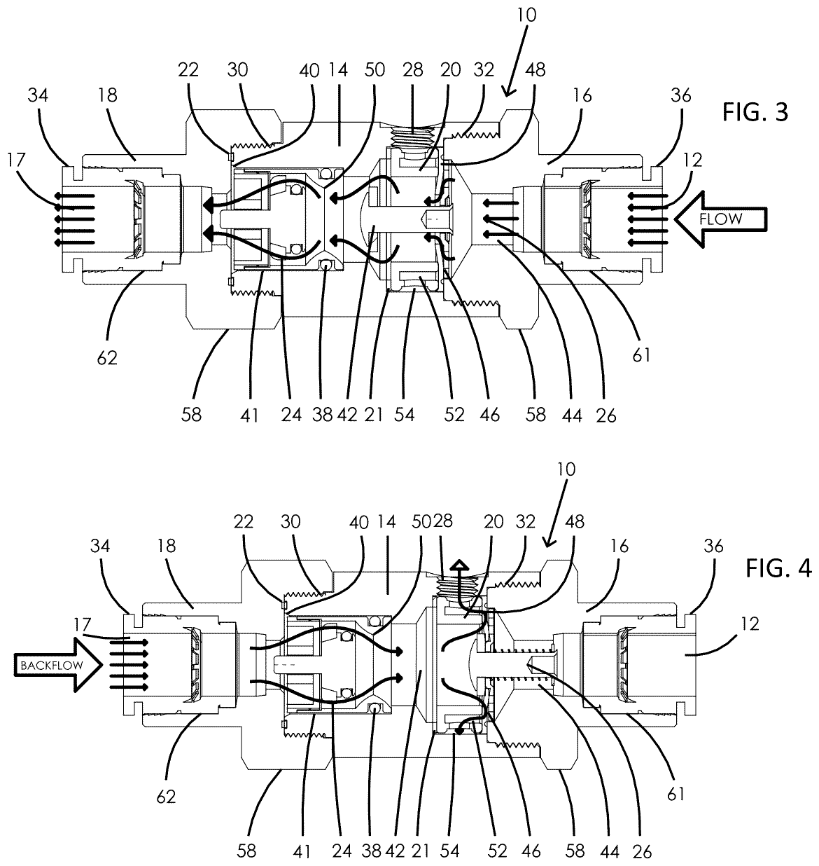

In operation, fluid enters the inlet 12 through the push-to-connect end 36, travels through the secondary check valve 26, the central section 14, and the primary check valve 24. Fluid then exits through the outlet 17 and push-to-connect end 34. This operation is illustrated in FIG. 3.

During backflow conditions, fluid is prevented from reentering the central section 14 by the primary check valve 24. If the primary check valve 24 fails, fluid is permitted to enter the internal passageway 42 of the central section 14. The secondary check valve 26 then prevents the fluid from exiting through the inlet 12 of the backflow preventor 10 by inflating, and fluid then exits through the vent assembly 20, 52, 54 and the vent opening 28. This signals to the user that the primary check valve 24 has failed and needs to be replaced.

As is evident, the primary check valve 24 and the secondary check valve 26 are independent and are not linked to one another by a common retainer. This is advantageous because it provides a simpler design. In particular, prior systems utilized a single retaining structure that held both check valves in position. In the present invention, each check valve is retained independently from the other. This aids in the servicing and repair of the device 10. In addition, because of the position of each check valve 24, 26 inside the housing, the backflow preventer may be easily repaired by unscrewing each individual end 30, 32 and replacing the check valves 24, 26 as needed. The present back flow preventer 10 is a three-piece design that allows the manufacturer to maintain consistent core dimensions for the central section 14, allowing the manufacturer to design multiple end configurations to couple with various fluid systems. This approach ensures cost-efficiency and a diverse range of solutions in the market.

The material used for the central section 14, the inlet section 16, the outlet section 18, and the cylindrical retainer 20 all consist of AISI 304. This is due to the material's cost efficiency in relation to brass, as well as it being on the list of approved materials under NSF/ANSI 61. Furthermore, SS 304 lacks copper, which reacts with carbonic acid. The other materials consist of EPDM (gaskets and O-rings), SS 316 (springs), Acetal (Neoperl Check Valve), and Technical Polymer (NSF Cartridge). The media of the fluid system, whether that be backflow media or inlet supplied media, does not come in contact with any materials not approved by NSF/ANSI 61 while operating within the constraints of the present invention.

According to the invention, a back flow preventer includes a housing, an internal passageway, a primary check valve, a secondary check valve and a vent assembly. The housing has an inlet section defining an inlet, a central section, and an outlet section defining an outlet. The inlet section, central section and outlet section are coupled together and axially aligned with one another along a longitudinal axis. The internal passageway is defined through the housing between the inlet and the outlet. The primary check valve is positioned in the housing and coupled between the central section and the outlet section in the internal passageway. The secondary check valve is positioned in the housing and coupled between the central section and the inlet section in the internal passageway. The vent assembly is positioned in the central section and coupled to a vent opening. The primary check valve is retained in the housing independently from the secondary check valve.

The back flow preventer may also include a recessed opening formed in the inlet and the outlet, and an inlet connector and an outlet connector, each of which is positioned in the respective recessed opening. The inlet connector may be a push-to-connect cartridge and the outlet connector may be a push-to-connect cartridge. The inlet and outlet connectors may be press-fit into their respective recessed openings.

The vent assembly may include a retaining element positioned in the internal passageway of the central section downstream of the secondary check valve for assisting in retaining the secondary check valve inside the internal passageway. The retaining element may be a cylindrical member fitted inside the internal passageway of the central section. The vent assembly may also include a gasket coupled between the secondary check valve and the retaining element. The gasket may be bendable. When a back flow condition is encountered, a flow of fluid inside the central section causes the gasket to bend towards the inlet 12 to seal off the internal passageway adjacent the secondary check valve and to open a vent passageway so that fluid may exit through the vent opening.

The primary check valve may be mounted in a recess defined in the central section at an outlet end of the central section adjacent the outlet section. The primary check valve may be retained in the recess of the central section by a part of the outlet section that abuts the primary check valve. The primary check valve may be press fit into the recess of the central section.

During a back flow condition where the primary check valve has failed, fluid is deterred from passing through the secondary check valve. Fluid exits through the vent assembly and the vent opening, indicating to a user that the primary check valve has failed.

The primary check valve is a NEOPERL valve and the secondary check valve is a diaphragm valve. The secondary check valve is spaced from the primary check valve. The inlet section, central section, and outlet sections are coupled together by screw threads. The backflow preventer may also include external means for screwing the inlet, outlet and central sections together.

The vent opening may be positioned closer to the inlet than the outlet. The primary check valve may be spaced from the retaining element.

According to another embodiment of the invention, a back flow preventer includes a housing, a longitudinally extending internal passageway, a primary check valve, a secondary check valve, and a vent assembly. The housing has an inlet section defining an inlet, a central section, and an outlet section defining an outlet, with the inlet section, central section and outlet section being coupled together and axially aligned with one another along a longitudinal axis. The central section is positioned between the inlet section and the outlet section. The internal passageway is defined through the housing between the inlet and the outlet. The primary check valve is positioned in the housing and the secondary check valve is positioned in the housing upstream of the primary check valve adjacent the inlet. The vent assembly is positioned in the central section and coupled to a vent opening. The vent assembly includes a retaining element positioned inside the internal passageway for retaining the secondary check valve in the housing. The primary check valve is positioned downstream of the secondary check valve and the primary check valve is spaced from the secondary check valve and the retaining element.

The primary check valve may be coupled to the central section adjacent the outlet section. The secondary check valve may be coupled to the inlet section and may be extendable into the central section. The retaining element may be positioned adjacent the secondary check valve for aiding in retention of the secondary check valve in the internal passageway.

The inlet section may be coupled to the central section via screw threads. The central section may be coupled to the outlet section via screw threads. The primary check valve may be insertable into and removable from the housing by unscrewing the outlet section from the central section. The secondary check valve may be insertable into and removable from the housing by unscrewing the inlet section from the central section.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The invention is, therefore, claimed in any of its forms or modifications within the proper scope of the appended claims (if any) appropriately interpreted by those skilled in the art.

What is claimed is:

1. A back flow preventer comprising:
a housing having an inlet section defining an inlet, a central section, and an outlet section defining an outlet, with the inlet section, central section and outlet section being coupled together and axially aligned with one another along a longitudinal axis;
an internal passageway defined through the housing between the inlet and the outlet;
a primary check valve positioned in the housing and coupled between the central section and the outlet section in the internal passageway;
a secondary check valve positioned in the housing and coupled between the central section and the inlet section in the internal passageway; and
a vent assembly positioned in the central section and coupled to a vent opening;
wherein the primary check valve is retained in the housing independently from the secondary check valve.

2. The back flow preventer of claim 1, further comprising a recessed opening formed in the inlet and the outlet, and an inlet connector and an outlet connector, each of which is positioned in the respective recessed opening.

3. The back flow preventer of claim 2, wherein the inlet connector is a push-to-connect cartridge and the outlet connector is a push-to-connect cartridge, and the inlet and outlet connectors are press-fit into their respective recessed openings.

4. The back flow preventer of claim 1, wherein the vent assembly includes a retaining element positioned in the internal passageway of the central section downstream of the secondary check valve for assisting in retaining the secondary check valve inside the internal passageway.

5. The back flow preventer of claim 4, wherein the retaining element is a cylindrical member fitted inside the internal passageway of the central section.

6. The back flow preventer of claim 4, wherein the vent assembly further comprises a gasket coupled between the secondary check valve and the retaining element.

7. The back flow preventer of claim 6, wherein the gasket is bendable and when a back flow condition is encountered, a flow of fluid inside the central section causes the gasket to bend towards the inlet end to seal off the internal passageway adjacent the secondary check valve and to open a vent passageway so that fluid may exit through the vent opening.

8. The back flow preventer of claim 1, wherein the primary check valve is mounted in a recess defined in the central section at an outlet end of the central section adjacent the outlet section.

9. The back flow preventer of claim 8, wherein the primary check valve is retained in the recess of the central section by a part of the outlet section that abuts the primary check valve.

10. The back flow preventer of claim 9, wherein the primary check valve is press fit into the recess of the central section.

11. The back flow preventer of claim 1, wherein during a back flow condition where the primary check valve has failed, fluid is deterred from passing through the secondary check valve and fluid exits through the vent assembly and the vent opening, indicating to a user that the primary check valve has failed.

12. The back flow preventer of claim 1, wherein the primary check valve is a NEOPERL valve and the secondary check valve is a diaphragm valve.

13. The back flow preventer of claim 1, wherein the secondary check valve is spaced from the primary check valve.

14. The back flow preventer of claim 1, wherein the inlet section, central section, and outlet sections are coupled together by screw threads.

15. The back flow preventer of claim 14, further comprising external means for screwing the inlet, outlet and central sections together.

16. The back flow preventer of claim 1, wherein the vent opening is positioned closer to the inlet than the outlet.

17. The back flow preventer of claim 4, wherein the primary check valve is not linked to the retaining element.

18. A back flow preventer comprising:
a housing having an inlet section defining an inlet, a central section, and an outlet section defining an outlet, with the inlet section, central section and outlet section being coupled together and axially aligned with one another along a longitudinal axis, and the central section being positioned between the inlet section and the outlet section;
a longitudinally extending internal passageway defined through the housing between the inlet and the outlet;
a primary check valve positioned in the housing;
a secondary check valve positioned in the housing upstream of the primary check valve adjacent the inlet; and
a vent assembly positioned in the central section and coupled to a vent opening, the vent assembly including a retaining element positioned inside the internal passageway for retaining the secondary check valve in the housing;
wherein the primary check valve is positioned downstream of the secondary check valve and the primary check valve is spaced from the secondary check valve and the retaining element.

19. The back flow preventer of claim 18, wherein the primary check valve is coupled to the central section adjacent the outlet section, the secondary check valve is coupled to the inlet section and is extendable into the central section, and the retaining element is positioned adjacent the secondary check valve for aiding in retention of the secondary check valve in the internal passageway.

20. The back flow preventer of claim 18, wherein the inlet section is coupled to the central section via screw threads, the central section is coupled to the outlet section via screw threads, the primary check valve is insertable into and removable from the housing by unscrewing the outlet section from the central section, and the secondary check valve is insertable into and removable from the housing by unscrewing the inlet section from the central section.
